(19) United States
(12) Patent Application Publication
(10) Pub. No.: US 2018/0091290 A1
(43) Pub. Date: Mar. 29, 2018

(54) METHOD FOR PERFORMING SENSOR CLOCK ESTIMATION OF ONE OR MORE SENSORS IN ELECTRONIC DEVICE, AND ASSOCIATED APPARATUS

(71) Applicant: MEDIATEK INC., Hsin-Chu (TW)

(72) Inventor: Chin Lung Li, Taoyuan City (TW)

(21) Appl. No.: 15/655,916

(22) Filed: Jul. 21, 2017

Related U.S. Application Data
(60) Provisional application No. 62/399,539, filed on Sep. 26, 2016.

(51) Int. Cl. H04L 7/033; H04L 7/00

(52) U.S. Cl. CPC H04L 7/0331; H04L 7/0087

(57) ABSTRACT

A method for performing sensor clock estimation of one or more sensors in an electronic device and an associated apparatus are provided. The method may include: receiving sensor data from a sensor within the one or more sensors when polling the sensor; obtaining a data quantity, wherein the data quantity indicates a number of samples within the sensor data received from the sensor; estimating a polling time latency and a sensor clock error at least according to the data quantity with aid of at least one estimation model; and based on the polling time latency and the sensor clock error, generating a plurality of timestamps of the sensor data received from the sensor, for performing an action according to the sensor data from the sensor, wherein the timestamps indicate sampling time of at least one portion of the samples, respectively.

### CROSS REFERENCE TO RELATED APPLICATIONS

This application claims the benefit of U.S. Provisional Application No. 62/399,539, which was filed on Sep. 26, 2016, and is included herein by reference.

### BACKGROUND

The present invention relates to a sensor clock (e.g. a clock in a sensor), and more particularly, to a method for performing sensor clock estimation of one or more sensors in an electronic device, and an associated apparatus.

An electronic device, such as a mobile phone, a wearable device, a tablet, a notebook, etc., may comprise one or more slave devices. Slave devices in electronic devices have become more complicated and powerful. For example, a slave device such as a sensor may have its own clock, analog-to-digital converter (ADC), memory, etc. integrated into the sensor. The sensor clock may be implemented with its own clock generating component (e.g. oscillator). The clock of the sensor may be referred to as the sensor clock, and the sensor having its own clock, ADC, memory, etc. may be referred to as the digital sensor, for preventing confusion. Some problems may occur when utilizing sensor data from the digital sensor. For example, as the sensor clock is typically implemented with a low cost oscillator, the electronic device may encounter a clock drift problem regarding the sensor clock when trying to determine the sampling time of the samples within the sensor data. For another example, as the sensor clock may not be related to a system clock of the electronic device (e.g. the frequency of the sensor clock is not a multiple of that of the system clock), the electronic device may encounter a jitter problem when trying to determine the sampling time of the samples within the sensor data (e.g. in a situation where the timing of the ticks of the sensor clock is unknown).

Some related art methods are proposed to try solving one or more of the problems. However, side effects may be introduced. One of the related art methods suggests implementing a dedicated interrupt pin of the digital sensor, for sending an interrupt signal from the digital sensor through an interrupt line coupled between an additional pin of a processor (e.g. an application processor) of the electronic device and the dedicated interrupt pin. As a result, both of the pin count of the digital sensor and the pin count of the processor are increased. In addition, in a situation where there are multiple digital sensors (e.g. one or more accelerometer sensors, one or more gyro sensors, one or more magnetometer sensors, one or more barometer sensors, etc.), they may frequently wake up the processor, so the power consumption of the electronic device is increased. Another of the related art methods suggests implementing a dedicated clock correction pin of the digital sensor, for sending a clock correction signal from the digital sensor through a clock correction line coupled between the processor and the dedicated clock correction pin, causing the pin count of the digital sensor to be increased. Thus, there is a need for a novel method and associated structure to properly solve the existing problems without introducing unwanted side effects, or in a way that is less likely to introduce a side effect.

### SUMMARY

It is an objective of the claimed invention to provide a method for performing sensor clock estimation of one or more sensors in an electronic device, and an associated apparatus, in order to solve the above-mentioned problems.

It is another objective of the claimed invention to provide a method for performing sensor clock estimation of one or more sensors in an electronic device, and an associated apparatus, in order to guarantee the overall performance of the whole system.

According to at least one embodiment, a method for performing sensor clock estimation of one or more sensors in an electronic device is provided, where the method is applied to the electronic device. For example, the method may comprise: receiving sensor data from a sensor within the one or more sensors when polling the sensor, wherein polling the sensor is performed based on a polling clock of the electronic device, and the sensor performs sampling based on a sensor clock that is different from the polling clock; obtaining a first data quantity, wherein the first data quantity indicates a number of first samples within the sensor data received from the sensor; estimating a first polling time latency and a first sensor clock error at least according to the first data quantity with aid of at least one estimation model; and based on the first polling time latency and the first sensor clock error, generating a plurality of first timestamps of the sensor data received from the sensor, for performing an action according to the sensor data from the sensor, wherein the first timestamps indicate sampling time of at least one portion of the first samples, respectively.

According to at least one embodiment, an apparatus for performing sensor clock estimation of one or more sensors in an electronic device is provided. For example, the apparatus may comprise a processing circuit that is positioned in the electronic device, and the processing circuit is arranged to control at least one operation of the electronic device. The processing circuit receives sensor data from a sensor within the one or more sensors when polling the sensor, wherein polling the sensor is performed based on a polling clock of the electronic device, and the sensor performs sampling based on a sensor clock that is different from the polling clock. In addition, the processing circuit obtains a first data quantity, wherein the first data quantity indicates a number of first samples within the sensor data received from the sensor. Additionally, the processing circuit estimates a first polling time latency and a first sensor clock error at least according to the first data quantity with aid of at least one estimation model. Further, based on the first polling time latency and the first sensor clock error, the processing circuit generates a plurality of first timestamps of the sensor data received from the sensor, for performing an action according to the sensor data from the sensor, wherein the first timestamps indicate sampling time of at least one portion of the first samples, respectively.

The present invention method and the associated apparatus may solve problems existing in the related arts without introducing unwanted side effects, or in a way that is less likely to introduce a side effect. In addition, the present invention method and the associated apparatus can accurately determine the sampling time of the samples within the sensor data, having no need to implement any additional pin (e.g. the dedicated interrupt pin or the dedicated clock correction pin mentioned above) and the associated line (e.g. the interrupt line or the clock correction line). Therefore, the electronic device that is implemented according to the present invention method and the associated apparatus can perform an action (e.g. one or more operations) based on sensor data from the digital sensor with reduced or zero timing error (e.g. the first polling time latency, the first sensor clock error, etc.), to guarantee the overall performance of the electronic device. As a result, user experience of the user of the electronic device can be enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing sensor clock estimation of one or more sensors in an electronic device according to an embodiment of the present invention.

FIG. 2 is a diagram of an apparatus for performing sensor clock estimation of one or more sensors in an electronic device according to an embodiment of the present invention.

FIG. 3 illustrates an estimation control scheme applied to the apparatus shown in FIG. 1 according to an embodiment of the present invention.

FIG. 4 is a diagram of an apparatus for performing sensor clock estimation of one or more sensors in an electronic device according to another embodiment of the present invention.

FIG. 5 illustrates an estimation control scheme applied to the apparatus shown in FIG. 4 according to an embodiment of the present invention.

FIG. 6 illustrates some details regarding one or more estimation models according to an embodiment of the present invention.

FIG. 7 illustrates a trend of an estimation error regarding the one or more estimation models according to an embodiment of the present invention.

FIG. 8 illustrates reduction of a jitter effect according to an embodiment of the present invention.

FIG. 9 illustrates reduction of a sensor clock error according to an embodiment of the present invention.

FIG. 10 illustrates a working flow of a method for performing sensor clock estimation of one or more sensors in an electronic device according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

According to one or more embodiments, the present invention provides a method for performing sensor clock estimation of one or more sensors in an electronic device (e.g. a mobile phone, a wearable device, a tablet, a notebook, etc.) and an associated apparatus. The electronic device may comprise a processing circuit utilized as a master device, such as a processor (e.g. an application processor), and may further comprise a slave device such as any sensor within the one or more sensors. For example, the sensor components of the one or more sensors may be implemented with microelectromechanical (or micro-electro-mechanical) systems (MEMS) technologies, and therefore may be referred to as MEMS sensor components. In some examples, the sensor components of the one or more sensors may be implemented with any of other types of technologies. In addition, a clock generating component of the electronic device may generate a polling clock, and the one or more sensors may be polled based the polling clock. In some embodiments, the polling clock may be the clock of a processor, and the processor (e.g. an application processor) may have its own clock generating component to generate the processor clock, but the present invention is not limited thereto. In some other embodiments, polling the one or more sensors may be performed based on a clock of any of various types of circuits, such as a micro controller unit (MCU) having its own clock generating component for generating the clock thereof, a sensor hub having its own clock generating component for generating the clock thereof, etc. Examples of the polling clock may include, but are not limited to: the processor clock (e.g. the clock of the processor such as the application processor), the MCU clock (e.g. the clock of the MCU), and the sensor hub clock (e.g. the clock of the sensor hub). The sensor may have its own clock, analog-to-digital converter (ADC), memory, etc. integrated into the sensor, where the clock of the sensor may be referred to as the sensor clock, and the sensor having its own clock, ADC, memory, etc. may be referred to as the digital sensor, for preventing confusion. The sensor clock may not be related to the polling clock of the electronic device (e.g. the frequency of the sensor clock is not a multiple of that of the polling clock, or there is a significant drift of the frequency of the sensor clock due to variation of the chip temperature thereof while the frequency of the polling clock is much more stable). The sensor such as the aforementioned digital sensor may perform sampling based on the sensor clock to generate sensor data. When the electronic device (more particularly, the processor therein) performs operations based on the sensor data from the digital sensor for the user of the electronic device, the processor may need additional data such as the sampling time of the samples within the sensor data. As the digital sensor may not notify the processor of the sampling time of the samples, the processor should determine the sampling time of the samples by itself. The present invention method and the associated apparatus can accurately determine the sampling time of the samples within the sensor data, having no need to implement any additional pin (e.g. the dedicated interrupt pin or the dedicated clock correction pin mentioned above) and the associated line (e.g. the interrupt line or the clock correction line). Therefore, the electronic device that is implemented according to the present invention method and the associated apparatus can perform an action (e.g. one or more operations, such as that of a virtual reality (VR) system, an augmented reality (AR) system, a location and navigation system, an electronic image stabilization (EIS) system, etc.) based on the sensor data from the digital sensor with reduced or zero timing error (e.g. polling time latency, sensor clock error, etc.), to guarantee the overall performance of the electronic device. As a result, user experience of the user of the electronic device can be enhanced. Additionally, the present invention method and the associated apparatus may solve problems existing in the related arts without introducing unwanted side effects, or in a way that is less likely to introduce a side effect.

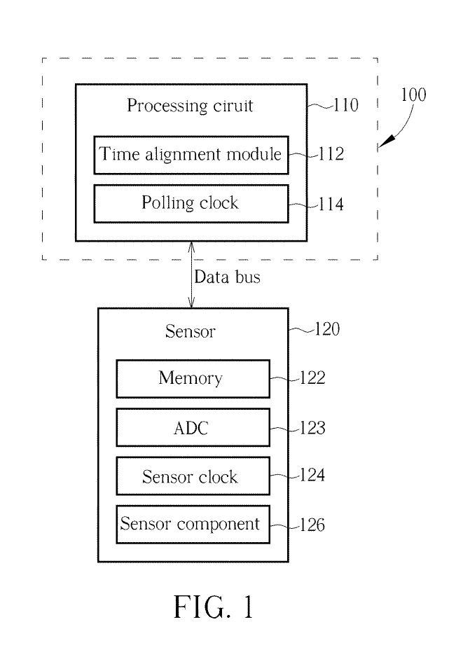

FIG. 1 is a diagram of an apparatus 100 for performing sensor clock estimation of one or more sensors in an electronic device such as that mentioned above according to an embodiment of the present invention, where the apparatus 100 may comprise at least one portion of the electronic device. For example, the apparatus 100 may comprise a portion of the electronic device, and more particularly, can be at least one hardware circuit such as at least one integrated circuit (IC) within the electronic device and associated circuits thereof. In another example, the apparatus 100 can be the whole of the electronic device. In another example, the apparatus 100 may comprise a system comprising the electronic device (e.g. a wireless communications system comprising the electronic device). Examples of the electronic device may include, but not limited to, a multifunctional mobile phone, a wearable device, a tablet and a notebook.

As shown in FIG. 1, the apparatus 100 may comprise a processing circuit 110 coupled to a sensor 120 through a data bus complying with a specific specification (e.g. any of existing specifications, such as Inter-Integrated Circuit (I²C) specification, Serial Peripheral Interface (SPI) specification, etc.), where the processing circuit 110 may comprise a time alignment module 112 and a polling clock 114, and the sensor 120 may comprise a memory 122, an ADC 123, a sensor clock 124, and a sensor component 126. The processing circuit 110 and the sensor 120 may be positioned within the electronic device. The processing circuit 110 can be taken as an example of the processing circuit utilized as the master device, and the sensor 120 can be taken as an example of the digital sensor. The time alignment module 112 may represent one or more program modules running on the processing circuit that operate according to the present invention method, and the polling clock 114 may be the system clock, the application processor (AP) clock, or any clock on which polling operations are based. According to some embodiments, the processing circuit 110 may be implemented with an application-specific integrated circuit (ASIC), and the time alignment module 112 may be implemented as one or more sub-circuits of the ASIC that operate according to the present invention method, where the polling clock may still represent the system clock, the AP clock, or any clock on which polling operations are based.

The sensor component 126 may be similar to an analog sensor that does not have its own clock, ADC, etc. The sensor component 126 may perform sensing operations to generate one or more analogue sensor signals indicating one or more sensing results. The ADC 123 may perform sampling operations on the one or more analogue sensor signals according to the clock signal of the sensor clock 124, to generate sampling results of the sampling operations. The sampling results may be stored in the memory 122, for being output as the samples within the sensor data. The sensor 120 may comprise a data pin for outputting the sensor data toward the processing circuit 110 through the data bus. In addition, the processing circuit 110 may perform polling operation on the sensor 120 to obtain the sensor data from the sensor 120. The sensor 120 may not send any clock synchronization data regarding the sensor clock 124, toward the processing circuit 110. Please note that implementing any of the dedicated interrupt pin or the dedicated clock correction pin mentioned above is not required, and implementing any of the interrupt line or the clock correction line is not required. Examples of the sensor 120 may include, but not limited to, an accelerometer sensor, a gyro sensor, a magnetometer sensor, and a barometer sensor.

According to this embodiment, the processing circuit 110 (e.g. the time alignment module 112 running on the processing circuit) is capable of performing the sensor clock estimation to generate timestamps respectively corresponding to the samples within the sensor data from the sensor 120. For example, the processing circuit 110 (e.g. the time alignment module 112 running on the processing circuit) may collect the sensor data from the sensor 120, and may perform the sensor clock estimation with the aid of calculations based on one or more estimation models (e.g. a motion model and a measurement model), to accurately determine the timestamps that respectively indicate the sampling time of the samples within the sensor data. As the timestamps indicate the sampling time of the samples, respectively, the processing circuit 110 can control the electronic device to perform an action (e.g. one or more operations such as that mentioned above) based on the sensor data with reduced or zero timing error (e.g. polling time latency, sensor clock error, etc.), to guarantee the overall performance of the electronic device.

According to some embodiments, the architecture shown in FIG. 1 may vary. For example, the number of sensors (e.g. the digital sensors) may be increased, and the number of time alignment modules may be increased correspondingly. For another example, the number of sensors (e.g. the digital sensors) may be increased, where multiple sensors may correspond to one time alignment module such as the time alignment module in the architecture shown in FIG. 1.

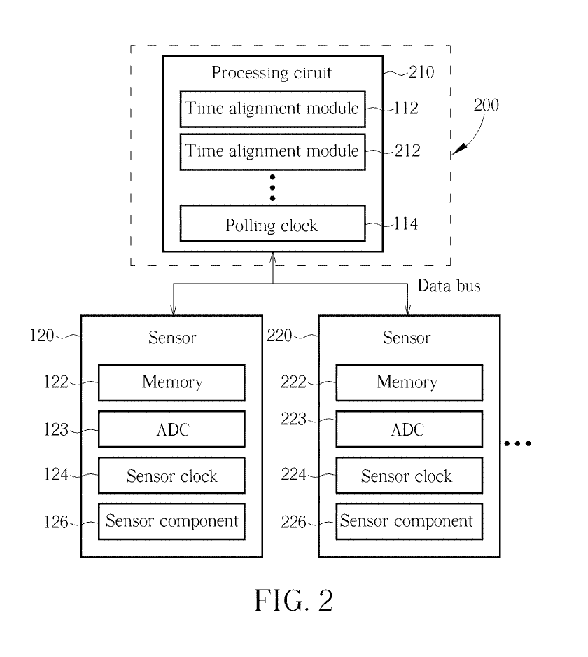

FIG. 2 is a diagram of an apparatus 200 for performing sensor clock estimation of one or more sensors in an electronic device such as that mentioned above according to an embodiment of the present invention, where the apparatus 200 may comprise at least one portion (e.g. a portion or all) of the electronic device. As shown in FIG. 2, the apparatus 200 may comprise a processing circuit 210 coupled to the sensor 120 through a data bus such as that mentioned above, and one or more additional sensors such as the sensor 220, etc. may be coupled to the processing circuit 210 through the data bus, where the processing circuit 210 may comprise the time alignment module 112 and one or more additional time alignment modules such as a time alignment module 212, etc. and comprise the polling clock 114, and the sensor 220 may comprise a memory 222, an ADC 223, a sensor clock 224, and a sensor component 226. The processing circuit 210 and the sensors 120, 220, etc. may be positioned within the electronic device. The processing circuit 210 can be taken as another example of the processing circuit utilized as the master device, and each of the one or more additional sensors such as the sensor 220, etc. can be taken as another example of the digital sensor. Similarly, the time alignment module 212 may represent one or more program modules running on the processing circuit that operate according to the present invention method. According to some embodiments, the processing circuit 210 may be implemented with an ASIC, and the time alignment module 112 and the one or more additional time alignment modules such as a time alignment module 212, etc. may be implemented as sub-circuits of the ASIC that operate according to the present invention method, respectively, where the polling clock may still represent the system clock, the AP clock, or any clock on which polling operations can be based.

Some implementation details of the apparatus 200 may be similar to that of the apparatus 100 shown in FIG. 1. For example, the operations that the one or more additional time alignment modules such as the time alignment module 212, etc. perform with respect to the one or more additional sensors such as the sensor 220, etc., respectively, maybe similar to the operations that the time alignment module 112 performs with respect to the sensor 120. In addition, the operations that the one or more additional sensors such as the sensor 220, etc. perform, respectively, may be similar to the operations that the sensor 120 performs, where the sensing operations may vary, depending on whether the sensor component(s) of the one or more additional sensors (e.g. the sensor component 226) belong to a sensor type different from that of the sensor component 126. Examples of the one or more additional sensors such as the sensor 220, etc. may include, but not limited to, accelerometer sensors, gyro sensors, magnetometer sensors, and a barometer sensors.

Please note that implementing any of the dedicated interrupt pin or the dedicated clock correction pin mentioned above is not required, and implementing any of the interrupt line or the clock correction line is not required. According to this embodiment, the processing circuit 210 (e.g. the time alignment modules 112, 212, etc. running on the processing circuit) is capable of performing the sensor clock estimation of the sensors 120, 220, etc., respectively, to generate the timestamps respectively corresponding to the samples within the sensor data from the sensors 120, 220, etc., respectively. For brevity, similar descriptions for this embodiment are not repeated in detail here.

According to some embodiments, one or more control schemes of the present invention method may be applied to the associated apparatus (e.g. the apparatus 100, the apparatus 200, etc.) to estimate a plurality of parameters according to the one or more estimation models (e.g. the motion model and the measurement model). For example, the parameters may comprise a sensor clock error (ε) regarding the time interval (Δt) of a sensor clock. The time interval (Δt) may represent an interval between two sampling time points of two samples continuously generated according to a clock signal of this sensor clock. When there is no drift of the sensor clock, the time interval (Δt) may represent the period of the clock signal of this sensor clock; otherwise, the time interval (Δt) may vary. In addition, the parameters may further comprise a polling time latency (T−Tₐ), such as the latency between the polling time and the sampling time of the latest sample (e.g. a sample that is latest generated before it is received from the digital sensor during polling). The polling time latency (T−Tₛ) may represent a latency between a polling time point the processing circuit of the present invention apparatus (e.g. the processing circuit 110, 210, etc.) polls the sensor comprising this sensor clock and a sampling time point of a sample generated according to the clock signal of this sensor clock.

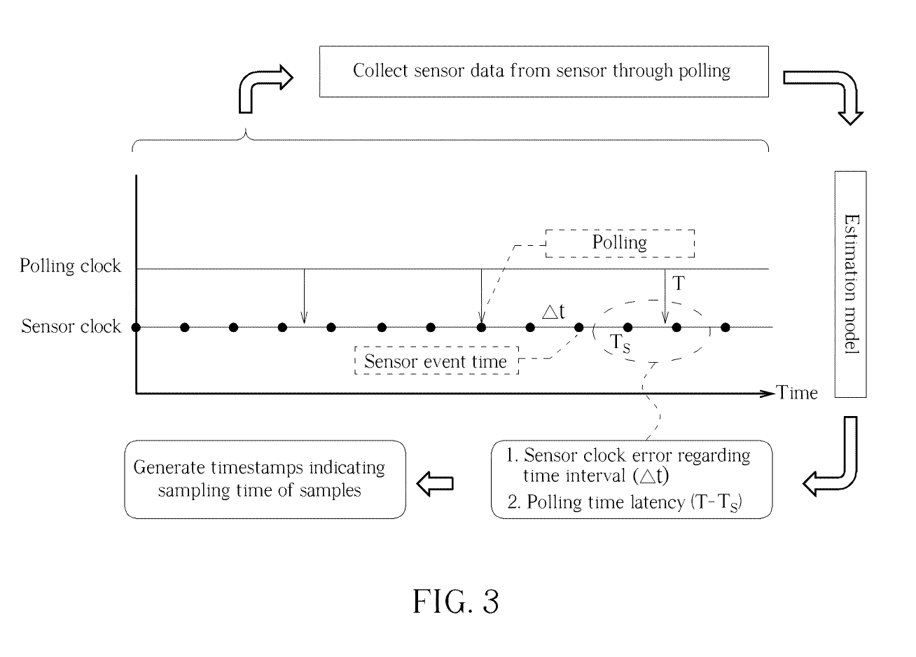

FIG. 3 illustrates an estimation control scheme applied to the apparatus 100 shown in FIG. 1 according to an embodiment of the present invention. The control scheme shown in FIG. 3 can be taken as an example of the one or more control schemes of the present invention method. According this embodiment, the processing circuit 110 (e.g. the time alignment module 112) may receive the sensor data (e.g. raw data) from the sensor 120 (e.g. the memory 122 therein) when polling the sensor 120 (labeled “Collect sensor data from sensor through polling” in FIG. 3, for brevity), where polling the sensor 120 is performed based on the polling clock 114 such as the AP clock, system clock, or any other clock on which the polling operations can be based. In addition, the processing circuit 110 (e.g. the time alignment module 112) may obtain a first data quantity that indicates a number of first samples within the sensor data received from the sensor 120. The processing circuit 110 (e.g. the time alignment module 112) may estimate a first polling time latency and a first sensor clock error with regard to the sensor 120 at least according to the first data quantity with the aid of the one or more estimation models (labeled “Estimation model” in FIG. 3). The first polling time latency can be taken as an example of the polling time latency (T−Tₛ), and the first sensor clock error can be taken as an example of the sensor clock error (ε). Based on the first polling time latency and the first sensor clock error, the processing circuit 110 (e.g. the time alignment module 112) may generate a plurality of first timestamps of the sensor data received from the sensor 120, for performing an action (e.g. one or more operations such as that mentioned above) according to the sensor data from the sensor 120, where the first timestamps may indicate the sampling time of at least one portion (e.g. a portion or all) of the first samples, respectively (labeled “Generate timestamps indicating sampling time of samples” in FIG. 3, for brevity). For example, the dots on the timing chart shown in FIG. 3 that are illustrated for the sensor clock (e.g. the sensor clock of the sensor 120) may represent the sampling time of the samples (labeled “Sensor event time” in FIG. 3, for brevity, where generating a sample by performing sampling may be regarded as a sensor event), and may also represent the ticks of the sensor clock. The downward arrows on the timing chart shown in FIG. 3 that are illustrated for the polling clock 114 may represent the polling operations that the processing circuit 110 (e.g. the time alignment module 112) performs on the sensor 120 (labeled “Polling” in FIG. 3), and the time points of the polling operations may represent the polling time, and may also represent the ticks of the polling clock 114.

The estimation control scheme shown in FIG. 3 may also be applied to the apparatus 200 shown in FIG. 2. For example, the operations that the processing circuit 210 (e.g. the time alignment module 112 thereof) performs with regard to the sensor 120 may be similar to the operations that the processing circuit 110 (e.g. the time alignment module 112 thereof) performs with regard to the sensor 120. In addition, the operations that the processing circuit 210 (e.g. other time alignment module(s) such as the time alignment module 212, etc.) performs with regard to other sensor(s) within the apparatus 200 (e.g. the sensor 220, etc.) may be similar to the operations that the processing circuit 210 (e.g. the time alignment module 112 thereof) performs with regard to the sensor 120. According to some embodiments, the processing circuit 210 (e.g. the time alignment module 212) may receive the sensor data (e.g. raw data) from the sensor 220 (e.g. the memory 222 therein) when polling the sensor 220 (labeled “Collect sensor data from sensor through polling” in FIG. 3, for brevity), where polling the sensor 220 is performed based on the polling clock 114. In addition, the processing circuit 210 (e.g. the time alignment module 212) may obtain a second data quantity that indicates a number of second samples within the sensor data received from the sensor 220. The processing circuit 210 (e.g. the time alignment module 212) may estimate a second polling time latency and a second sensor clock error with regard to the sensor 220 at least according to the second data quantity with the aid of the one or more estimation models (labeled “Estimation model” in FIG. 3). The second polling time latency can be taken as another example of the polling time latency (T−Tₛ), and the second sensor clock error can be taken as another example of the sensor clock error (ε). Based on the second polling time latency and the second sensor clock error, the processing circuit 210 (e.g. the time alignment module 212) may generate a plurality of second timestamps of the sensor data received from the sensor 220, for performing an action (e.g. one or more operations such as that mentioned above) according to the sensor data from the sensor 220, where the second timestamps may indicate the sampling time of at least one portion (e.g. a portion or all) of the second samples, respectively (labeled “Generate timestamps indicating sampling time of samples” in FIG. 3, for brevity). For example, the dots on the timing chart shown in FIG. 3 that are illustrated for the sensor clock (e.g. the sensor clock of the sensor 220) may represent the sampling time of the samples (labeled “Sensor event time” in FIG. 3, for brevity), and may also represent the ticks of the sensor clock. The downward arrows on the timing chart shown in FIG. 3 that are illustrated for the polling clock 114 may represent the polling operations that the processing circuit 210 (e.g. the time alignment module 212) performs on the sensor 220 (labeled “Polling” in FIG. 3), and the time points of the polling operations may represent the polling time, and may also represent the ticks of the polling clock 114.

According to some embodiments, the operations that the processing circuit 210 (e.g. the time alignment module 112 thereof) performs with regard to the sensor 120 may vary, and/or the operations that the processing circuit 210 (e.g. the other time alignment module(s) such as the time alignment module 212, etc.) performs with regard to the other sensor(s) within the apparatus 200 (e.g. the sensor 220, etc.) may vary. According to some embodiments, the action performed according to the sensor data from the sensor 220 may be the same as the action performed according to the sensor data from the sensor 120. According to some embodiments, the action performed according to the sensor data from the sensor 220 may be different from the action performed according to the sensor data from the sensor 120.

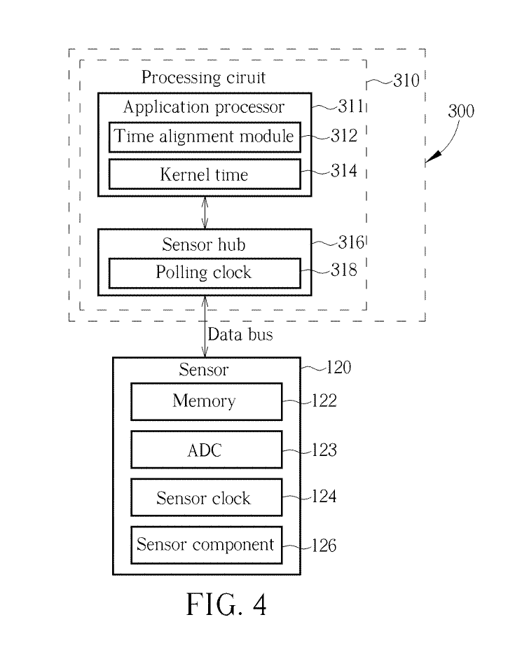

FIG. 4 is a diagram of an apparatus 300 for performing sensor clock estimation of one or more sensors in an electronic device such as that mentioned above according to another embodiment of the present invention, where the apparatus 300 may comprise at least one portion (e.g. a portion or all) of the electronic device. As shown in FIG. 3, the apparatus 300 may comprise a processing circuit 310 coupled to the sensor 120 through a data bus such as that mentioned above, where the processing circuit 310 may comprise an application processor 311 and a sensor hub 316, in which the polling clock 318 may be a clock of the sensor hub 316. The processing circuit 310 and the sensor 120 may be positioned within the electronic device. The application processor 311 may be taken as an example of the processor, and the sensor hub 316 may be implemented as a secondary circuit configured to collect data from the one or more sensors for the processor. The processing circuit 310 may perform internal clock synchronization (sync) between the application processor 311 and the sensor hub 316, to make the kernel time 314 of the application processor 311 and the polling clock 318 of the sensor hub 316 be synchronized with each other. As the kernel time 314 of the application processor 311 and the polling clock 318 of the sensor hub 316 are synchronized with each other, the operations that the time alignment module 312 within the application processor 311 performs with respect to the sensor 120 may be similar to the operations that the time alignment module 112 performs with respect to the sensor 120. Please note that the architecture shown in FIG. 4 maybe regarded as a sensor-hub platform, while the architecture shown in any of FIGS. 1-2 may be regarded as a non-sensor-hub platform. The processing circuit 310 can be taken as yet another example of the processing circuit utilized as the master device. For brevity, similar descriptions for this embodiment are not repeated in detail here.

According to some embodiments, in a situation where there are multiple digital sensors, the one or more sensors such as the sensors 120, 220, etc. may be coupled to the sensor hub 316 through the same data bus. For brevity, similar descriptions for these embodiments are not repeated in detail here.

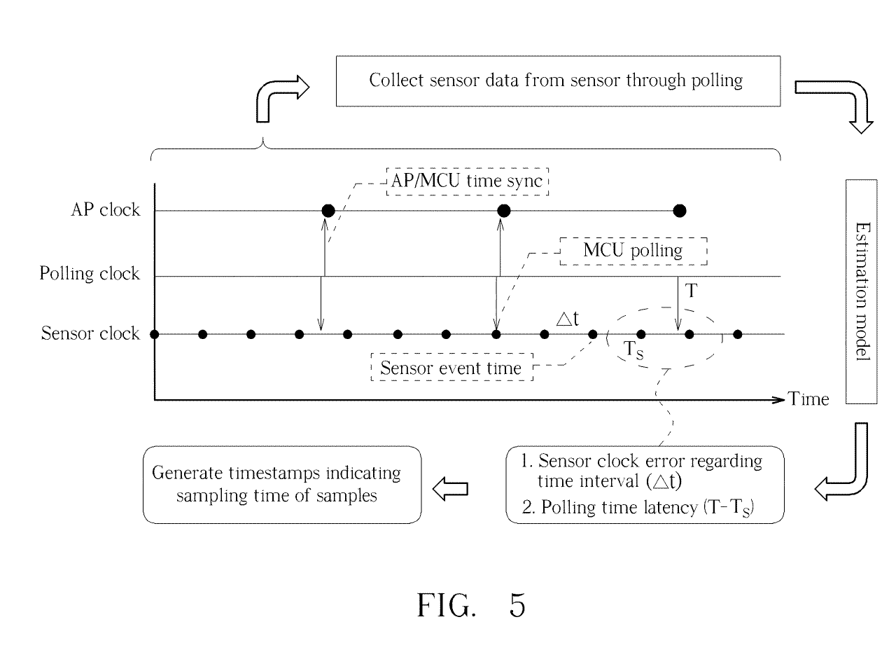

FIG. 5 illustrates an estimation control scheme applied to the apparatus 300 shown in FIG. 4 according to an embodiment of the present invention. The control scheme shown in FIG. 5 can be taken as another example of the one or more control schemes of the present invention method. The estimation control scheme shown in FIG. 5 may be applied to the apparatus 300 shown in FIG. 4. For example, the sensor hub 316 may comprise a micro controller unit (MCU) configured to control operations of the sensor hub 316. The kernel time 314 maybe regarded as the AP clock such as the clock of the application processor. The upward arrows on the timing chart shown in FIG. 5 that are illustrated for the polling clock may represent the internal clock synchronization operations that the processing circuit 310 performs. As the kernel time 314 of the application processor 311 and the polling clock 318 of the sensor hub 316 are synchronized with each other (labeled “AP/MCU time sync” in FIG. 5, for brevity), the operations that the processing circuit 310 (e.g. the time alignment module 312) performs with respect to the sensor 120 maybe similar to the operations that the processing circuit 110 (e.g. the time alignment module 112) performs with respect to the sensor 120. For brevity, similar descriptions for this embodiment are not repeated in detail here.

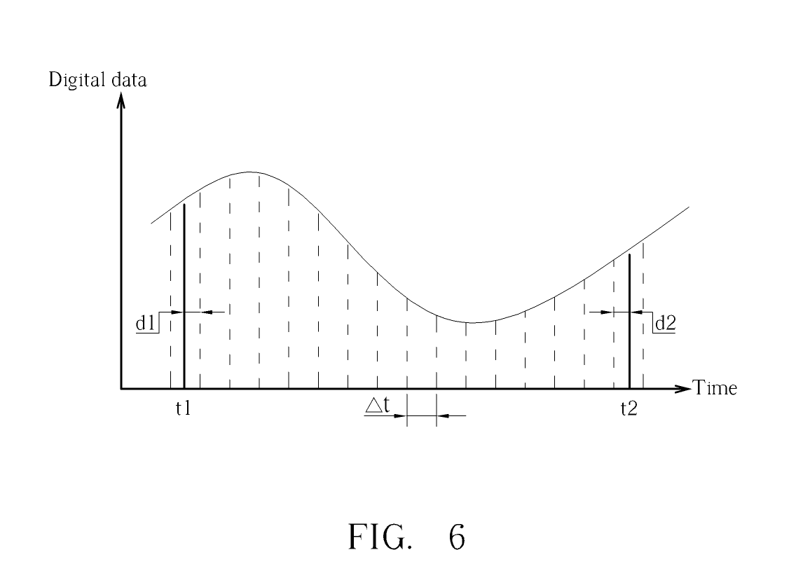

FIG. 6 illustrates some details regarding the one or more estimation models (e.g. the motion model) according to an embodiment of the present invention. The processing circuit of the present invention apparatus (e.g. the processing circuit 110, 210, 310, etc.) may subtract one from the first data quantity (e.g. a data quantity n) to generate a first difference (e.g. a difference value (n−1)), and divides a time difference (t2−t1) between time points t2 and t1 of two polling operations corresponding to the sensor 120 by the first difference (e.g. the difference value (n−1)) to generate a dividing result (e.g. (t2−t1)/(n−1)) as a first time interval between two first samples within the first samples, such as a time interval between two adjacent dashed lines within the vertical dashed lines shown in FIG. 6, where the first data quantity (e.g. the data quantity n) may indicate the number of first samples that are generated in the period between the time points t2 and t1 of the two polling operations corresponding to the sensor 120. The first time interval may be taken as an example of the time interval (Δt). According to this embodiment, the vertical dashed lines shown in FIG. 6 may represent the sampling times of a series of samples within the first samples, and the curve shown in FIG. 6 may represent the magnitude of the analog sensor signal generated by the sensor component 126, where the intersections of the curve and the vertical dashed lines may represent the sample values of the series of samples. For example, when there is no drift of the sensor clock 124, the time interval (Δt) may represent the period of the clock signal of the sensor clock 124, such as (1/f), where the symbol “f” may represent the frequency of the clock signal of the sensor clock 124; otherwise, the time interval (Δt) may vary. The maximum of each of the errors d1 and d2 may be equal to the time interval (Δt), while the minimum of each of the errors d1 and d2 may be equal to zero. In a situation where one or more of the errors d1 and d2 are not equal to zero, the dividing result (e.g. (t2−t1)/(n−1)) is not equal to the time interval (Δt). When the data quantity n increases, the dividing result (e.g. (t2−t1)/(n−1)) may approach the time interval (Δt). As long as the data quantity n is greater than or equal to a predetermined data quantity threshold, the dividing result (t2−t1)/(n−1)) may be regarded as a proper estimation value of the time interval (Δt), where the errors d1 and d2 become minor in this estimation.

In this manner, the processing circuit of the present invention apparatus (e.g. the processing circuit 110, 210, 310, etc.) may update the first time interval to monitor the first time interval (e.g. the interval between two sampling time points of two samples continuously generated by the sensor 120, such as the time interval (Δt) shown in FIG. 6), and may update the first polling time latency and the first sensor clock error at least according to the first time interval that is latest updated, for maintaining the accuracy of the first timestamps. For example, the processing circuit may estimate the first polling time latency according to the first time interval that is latest updated, and may estimate the first sensor clock error according to the first time interval that is latest updated and according to the first difference. According to some embodiment, the estimation of the first polling time latency may be performed according to the first time interval that is latest updated and according to a damping factor of the one or more estimation model (e.g. the measurement model), where the damping factor may emulate the damping applied to variation of the polling time latency (T−Tₛ). According to some embodiments, the processing circuit may perform calculations according to one or more state equations regarding the one or more estimation model, to estimate the sensor clock error (ε) regarding the time interval (Δt) and estimate the polling time latency (T−Tₛ). For example, the estimation of the polling time latency (T−Tₛ) such as the first polling time latency may be performed at least according to the first data quantity with aid of an estimation model (e.g. the measurement model), and the estimation of the sensor clock error (ε) such as the first sensor clock error may be performed at least according to the first data quantity with aid of another estimation model (e.g. the motion model). This is for illustrative purposes only, and is not meant to be a limitation of the present invention.

According to some embodiments, various types of estimation techniques may be applied to the processing circuit, and the processing circuit may perform the associated calculations of any of the types of estimation techniques, to estimate the sensor clock error (ε) regarding the time interval (Δt) and estimate the polling time latency (T−Tₛ). No matter which type of the types of estimation techniques is applied to the processing circuit, the processing circuit is capable of correctly determining the first timestamps to indicate the sampling time of the first samples of the sensor 120. As a result, the processing circuit may perform the action (e.g. the one or more operations) according to the sensor data from the sensor 120 and according to the first timestamps, to control the electronic device in response to the sensor data with reduced or zero timing error (e.g. the polling time latency (T−Tₛ), the sensor clock error (ε), etc.), to guarantee the overall performance of the electronic device.

According to some embodiments, the operations that the processing circuit 210 (e.g. the other time alignment module(s) such as the time alignment module 212, etc.) performs with regard to the other sensor(s) within the apparatus 200 (e.g. the sensor 220, etc.) may be similar to the operations that the processing circuit 210 (e.g. the time alignment module 112 thereof) performs with regard to the sensor 120. For example, the processing circuit 210 may subtract one from the second data quantity (e.g. the data quantity n) to generate a second difference (e.g. the difference value (n−1)), and divides a time difference (t2−t1) between time points t2 and t1 of two polling operations corresponding to the sensor 220 by the second difference (e.g. the difference value (n−1)) to generate a dividing result (e.g. (t2−t1)/(n−1)) as a second time interval between two second samples within the second samples, such as a time interval between two adjacent dashed lines within the vertical dashed lines shown in FIG. 6, where the second data quantity (e.g. the data quantity n) may indicate the number of second samples that are generated in the period between the time points t2 and t1 of the two polling operations corresponding to the sensor 220. The second time interval may be taken as an example of the time interval (Δt). According to these embodiment, the vertical dashed lines shown in FIG. 6 may represent the sampling times of a series of samples within the second samples, and the curve shown in FIG. 6 may represent the magnitude of the analog sensor signal generated by the sensor component 226, where the intersections of the curve and the vertical dashed lines may represent the sample values of the series of samples. For example, when there is no drift of the sensor clock 224, the time interval (Δt) may represent the period of the clock signal of the sensor clock 224, such as (1/f), where the symbol “f” may represent the frequency of the clock signal of the sensor clock 224; otherwise, the time interval (Δt) may vary. The maximum of each of the errors d1 and d2 may be equal to the time interval (Δt), while the minimum of each of the errors d1 and d2 may be equal to zero. In a situation where one or more of the errors d1 and d2 are not equal to zero, the dividing result (e.g. (t2−t1)/(n−1)) is not equal to the time interval (Δt). When the data quantity n increases, the dividing result (e.g. (t2−t1)/(n−1)) may approach the time interval (Δt). As long as the data quantity n is greater than or equal to a predetermined data quantity threshold such as that mentioned above, the dividing result (t2−t1)/(n−1)) may be regarded as a proper estimation value of the time interval (Δt), where the errors d1 and d2 become minor in this estimation.

In this manner, the processing circuit of the present invention apparatus (e.g. the processing circuit 210) may update the second time interval to monitor the second time interval (e.g. the interval between two sampling time points of two samples continuously generated by the sensor 220, such as the time interval (Δt) shown in FIG. 6), and may update the second polling time latency and the second sensor clock error at least according to the second time interval that is latest updated, for maintaining the accuracy of the second timestamps. For example, the processing circuit may estimate the second polling time latency according to the second time interval that is latest updated, and may estimate the second sensor clock error according to the second time interval that is latest updated and according to the second difference. For brevity, similar descriptions for these embodiments are not repeated in detail here.

According to some embodiment, the estimation of the second polling time latency may be performed according to the second time interval that is latest updated and according to the damping factor mentioned above. In some embodiment, the estimation of the polling time latency (T−Tₛ) such as the second polling time latency may be performed at least according to the second data quantity with aid of an estimation model (e.g. the measurement model), and the estimation of the sensor clock error (ε) such as the second sensor clock error may be performed at least according to the second data quantity with aid of another estimation model (e.g. the motion model).

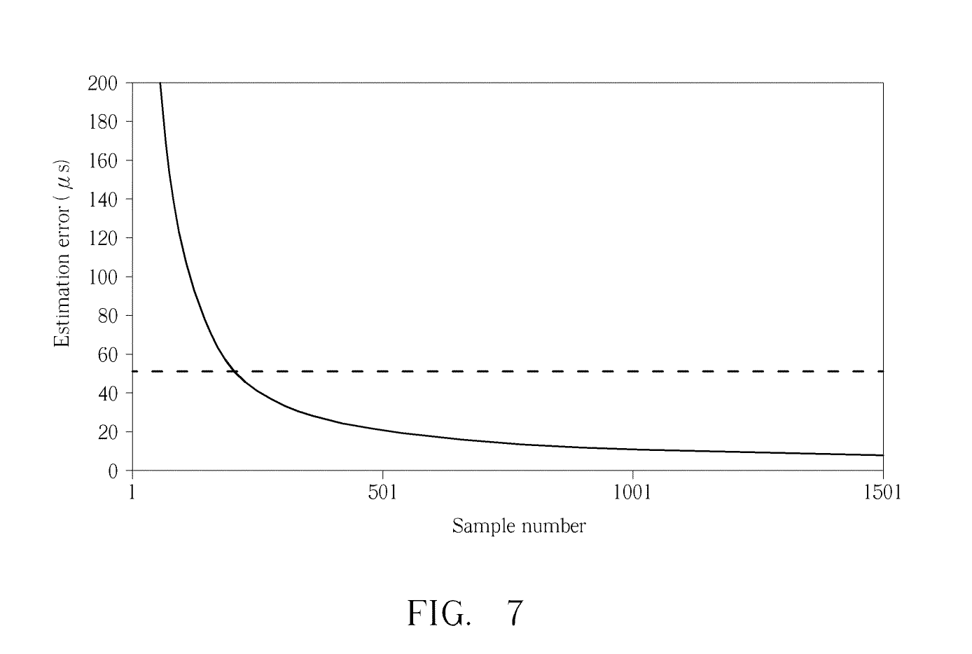

FIG. 7 illustrates a trend of the estimation error regarding the one or more estimation models (e.g. the motion model) according to an embodiment of the present invention. The horizontal axis may represent the sample number, and the vertical axis may represent the estimation error (e.g. in unit of microseconds (μs)). The estimation error may be taken as an example of the sensor clock error (ε) regarding the time interval (Δt), and the sample number may be taken as an example of the data quantity n. When the sample number increases, the estimation error decreases. For brevity, similar descriptions for this embodiment are not repeated in detail here.

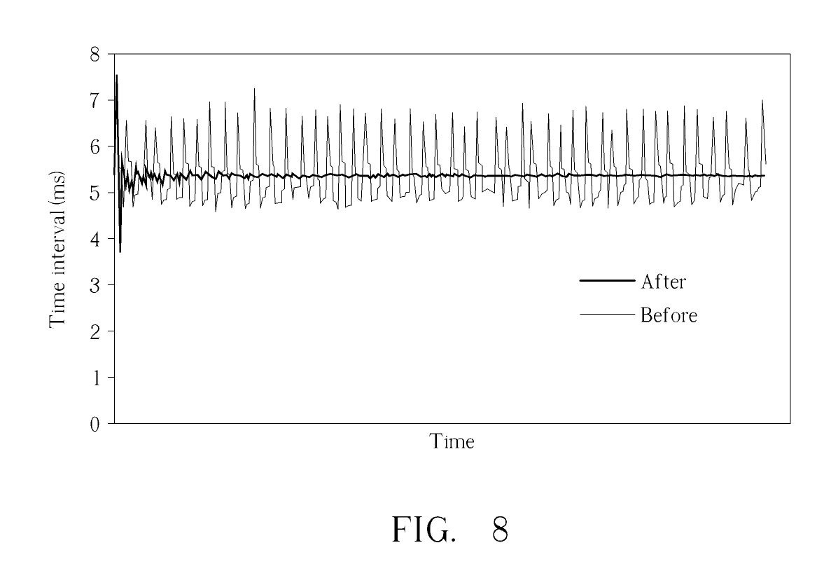

FIG. 8 illustrates reduction of the jitter effect according to an embodiment of the present invention. Two curves, such as a first curve labeled “Before” and a second curve labeled “After” are illustrated. The horizontal axis represents time. For the first curve, the vertical axis represents the time interval determined from simply polling without using any of the control schemes of the present invention method, where the standard deviation of the first curve is approximately 0.7 milliseconds (ms). For the second curve, the vertical axis represents the time interval determined based on the present invention method, such as the time interval (Δt) that is updated with respect to time according to the control schemes of the present invention method, where the standard deviation of the second curve is approximately 0.01 ms. Please note that the fluctuation in the beginning of the second curve should be omitted when calculating the standard deviation of the second curve, since the beginning of the second curve may correspond to an initial state of the sensor clock estimation. As shown in FIG. 8, after a small period of the fluctuation, the second curve becomes very smooth. As the standard deviation of the second curve is much less than that of the first curve, the jitter effect is greatly reduced by the present invention method. Thus, the electronic device that is implemented according to the present invention method and the associated apparatus will not be affected by the related art problems such as the jitter problem.

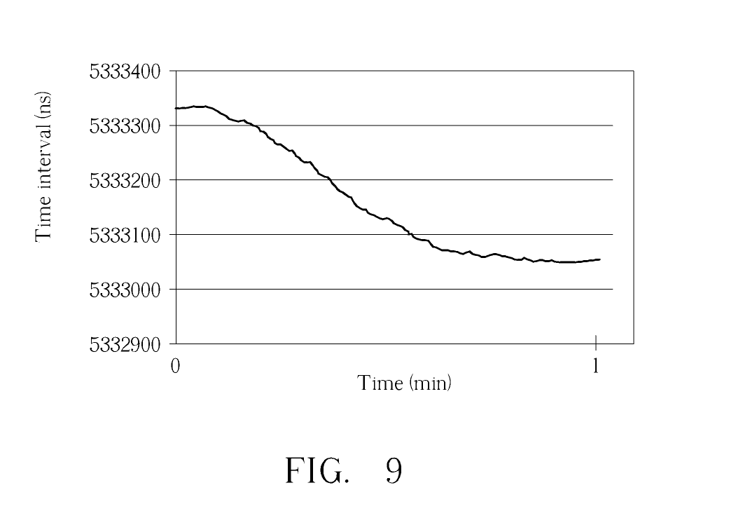

FIG. 9 illustrates reduction of a sensor clock error according to an embodiment of the present invention. The curve shown in FIG. 9 may be regarded as a long term version of the second curve shown in FIG. 8, where the horizontal axis still represents time. The scale of the horizontal axis of this embodiment is different from that of the embodiment shown in FIG. 8. For example, the number of samples corresponding to the curve shown in FIG. 9 is much greater than the number of samples corresponding to the second curve shown in FIG. 8. As shown in FIG. 9, the trend of the curve may reflect the drift of the sensor clock (e.g. the drift of the frequency of the sensor clock due to variation of the temperature of the sensor clock), which means the present invention method can minimize the sensor clock error (ε) regarding the time interval (Δt) and accurately determine the timestamps indicating the sampling time of the samples within the sensor data. When the frequency of the sensor clock varies due to the variation of the temperature of the sensor clock, the electronic device that is implemented according to the present invention method and the associated apparatus can detect the change of the time interval (Δt) in real time, and will not be affected by the related art problems such as the clock drift problem.

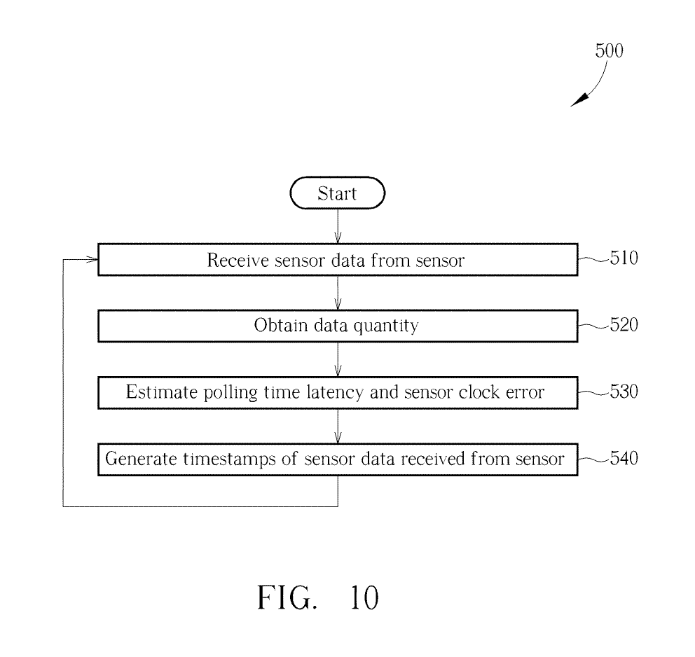

FIG. 10 illustrates a working flow 500 of the present invention method such as the method for performing the sensor clock estimation of the one or more sensors in the electronic device according to an embodiment of the present invention. The present invention method maybe applied to the present invention apparatus (e.g. the apparatus 100, 200, 300, etc.), and may also be applied to the processing circuit within the present invention apparatus (e.g. the processing circuit 110, 210, 310, etc.). The method may be described as follows.

In Step 510, the processing circuit may receive sensor data from a sensor (e.g. the sensor 120, 220, etc.) within the one or more sensors when polling the sensor, wherein polling the sensor is performed based on the polling clock, the sensor performs sampling based on the sensor clock of the sensor, and the sensor clock of the sensor and the polling clock are different from each other.

In Step 520, the processing circuit may obtain a data quantity (e.g. the first data quantity, the second data quantity, etc.), wherein the data quantity indicates a number of samples within the sensor data received from the sensor (e.g. the first samples from the sensor 120, the second samples from the sensor 220, etc.).

In Step 530, the processing circuit may estimate the polling time latency (T−Tₛ) (e.g. the first polling time latency, the second polling time latency, etc.) and the sensor clock error (ε) regarding the time interval (Δt) (e.g. the first sensor clock error, the second sensor clock error, etc.) at least according to the data quantity with the aid of at least one estimation model such as the one or more estimation models.

In Step 540, based on the polling time latency (T−Tₛ) and the sensor clock error (ε), the processing circuit may generate a plurality of timestamps of the sensor data received from the sensor (e.g. the first timestamps, the second timestamps, etc.), for performing an action (e.g. one or more operations such as that mentioned above) according to the sensor data from the sensor, wherein the timestamps indicate sampling time of at least one portion of the samples (e.g. the samples mentioned in Step 520), respectively.

Some implementation details of the working flow 500 have been described in one or more of the above embodiments. For brevity, similar descriptions for this embodiment are not repeated in detail here.

According to some embodiments, the types of estimation techniques that maybe applied to the processing circuit may include, but not limited to, average, least square, Kalman Filter, and particle filter. For example, the one or more estimation models maybe related to one or more of the above examples of estimation techniques. According to some embodiments, the present invention method and the associated apparatus may be applied to various types of systems such as a virtual reality (VR) system, an augmented reality (AR) system, a location and navigation system, and an electronic image stabilization (EIS) system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing sensor clock estimation of one or more sensors in an electronic device, the method being applied to the electronic device, the method comprising:
receiving sensor data from a sensor within the one or more sensors when polling the sensor, wherein polling the sensor is performed based on a polling clock of the electronic device, and the sensor performs sampling based on a sensor clock that is different from the polling clock;
obtaining a first data quantity, wherein the first data quantity indicates a number of first samples within the sensor data received from the sensor;
estimating a first polling time latency and a first sensor clock error at least according to the first data quantity with aid of at least one estimation model; and
based on the first polling time latency and the first sensor clock error, generating a plurality of first timestamps of the sensor data received from the sensor, for performing an action according to the sensor data from the sensor, wherein the first timestamps indicate sampling time of at least one portion of the first samples, respectively.

2. The method of claim 1, wherein the one or more sensors further comprises at least one other sensor; and the method further comprises:
receiving sensor data from the other sensor when polling the other sensor, wherein polling the other sensor is performed based on the polling clock, and the other sensor performs sampling based on another sensor clock that is different from the polling clock;
obtaining a second data quantity, wherein the second data quantity indicates a number of second samples within the sensor data received from the other sensor;
estimating a second polling time latency and a second sensor clock error at least according to the second data quantity with aid of at least one estimation model; and
based on the second polling time latency and the second sensor clock error, generating a plurality of second timestamps of the sensor data received from the other sensor, for performing the action or another action according to the sensor data from the other sensor, wherein the second timestamps indicate sampling time of at least one portion of the second samples, respectively.

3. The method of claim 2, further comprising:
subtracting one from the first data quantity to generate a first difference, and dividing a time difference between time points of two polling operations corresponding to the sensor by the first difference to generate a dividing result as a first time interval between two first samples within the first samples, wherein the first data quantity indicates the number of first samples that are generated in a period between the time points of the two polling operations corresponding to the sensor;
updating the first time interval to monitor the first time interval;
updating the first polling time latency and the first sensor clock error at least according to the first time interval that is latest updated, for maintaining accuracy of the first timestamps;
subtracting one from the second data quantity to generate a second difference, and dividing a time difference between time points of two polling operations corresponding to the other sensor by the second difference to generate a dividing result as a second time interval between two second samples within the second samples, wherein the second data quantity indicates the number of second samples that are generated in a period between the time points of the two polling operations corresponding to the other sensor;
updating the second time interval to monitor the second time interval; and
updating the second polling time latency and the second sensor clock error at least according to the second time interval that is latest updated, for maintaining accuracy of the second timestamps.

4. The method of claim 3, wherein:
estimating the first polling time latency comprises:
estimating the first polling time latency according to the first time interval that is latest updated;
estimating the first sensor clock error comprises:
estimating the first sensor clock error according to the first time interval that is latest updated and according to the first difference,
estimating the second polling time latency comprises:
estimating the second polling time latency according to the second time interval that is latest updated; and
estimating the second sensor clock error comprises:
estimating the second sensor clock error according to the second time interval that is latest updated and according to the second difference.

5. The method of claim 1, further comprising:
subtracting one from the first data quantity to generate a first difference, and dividing a time difference between time points of two polling operations corresponding to the sensor by the first difference to generate a dividing result as a first time interval between two first samples within the first samples, wherein the first data quantity indicates the number of first samples that are generated in a period between the time points of the two polling operations corresponding to the sensor;
updating the first time interval to monitor the first time interval; and
updating the first polling time latency and the first sensor clock error at least according to the first time interval that is latest updated, for maintaining accuracy of the first timestamps.

6. The method of claim 5, wherein:
estimating the first polling time latency comprises:
estimating the first polling time latency according to the first time interval that is latest updated; and
estimating the first sensor clock error comprises:
estimating the first sensor clock error according to the first time interval that is latest updated and according to the first difference.

7. The method of claim 6, wherein estimation of the first polling time latency is performed according to the first time interval that is latest updated and according to a damping factor of the estimation model, wherein the damping factor emulates damping applied to variation of the polling time latency.

8. The method of claim 1, wherein estimation of the first polling time latency is performed at least according to the first data quantity with aid of an estimation model; and estimation of the first sensor clock error is performed at least according to the first data quantity with aid of another estimation model.

9. The method of claim 1, further comprising:
performing the action according to the sensor data from the sensor and according to the first timestamps, to control the electronic device.

10. The method of claim 1, wherein the sensor comprises a sensor component, an analog-to-digital converter (ADC), and a memory; and the method further comprises:
utilizing the ADC to perform sampling operations on one or more analogue sensor signals of the sensor component according to a clock signal of the sensor clock of the sensor, to generate sampling results of the sampling operations, wherein the sampling results are stored in the memory as the first samples; and
utilizing a processing circuit to receive the sensor data from the sensor through a digital interface between the processing circuit and the sensor.

11. An apparatus for performing sensor clock estimation of one or more sensors in an electronic device, the apparatus comprising:
a processing circuit, positioned in the electronic device, arranged to control at least one operation of the electronic device, wherein:
the processing circuit receives sensor data from a sensor within the one or more sensors when polling the sensor, wherein polling the sensor is performed based on a polling clock of the electronic device, and the sensor performs sampling based on a sensor clock that is different from the polling clock;
the processing circuit obtains a first data quantity, wherein the first data quantity indicates a number of first samples within the sensor data received from the sensor;
the processing circuit estimates a first polling time latency and a first sensor clock error at least according to the first data quantity with aid of at least one estimation model; and
based on the first polling time latency and the first sensor clock error, the processing circuit generates a plurality of first timestamps of the sensor data received from the sensor, for performing an action according to the sensor data from the sensor, wherein the first timestamps indicate sampling time of at least one portion of the first samples, respectively.

12. The apparatus of claim 11, wherein the one or more sensors further comprises at least one other sensor; and wherein:
the processing circuit receives sensor data from the other sensor when polling the other sensor, wherein polling the other sensor is performed based on the polling clock, and the other sensor performs sampling based on another sensor clock that is different from the polling clock;
the processing circuit obtains a second data quantity, wherein the second data quantity indicates a number of second samples within the sensor data received from the other sensor;
the processing circuit estimates a second polling time latency and a second sensor clock error at least according to the second data quantity with aid of at least one estimation model; and
based on the second polling time latency and the second sensor clock error, the processing circuit generates a plurality of second timestamps of the sensor data received from the other sensor, for performing the action or another action according to the sensor data from the other sensor, wherein the second timestamps indicate sampling time of at least one portion of the second samples, respectively.

13. The apparatus of claim 12, wherein the processing circuit subtracts one from the first data quantity to generate a first difference, and divides a time difference between time points of two polling operations corresponding to the sensor by the first difference to generate a dividing result as a first time interval between two first samples within the first samples, wherein the first data quantity indicates the number of first samples that are generated in a period between the time points of the two polling operations corresponding to the sensor; the processing circuit updates the first time interval to monitor the first time interval, and updates the first polling time latency and the first sensor clock error at least according to the first time interval that is latest updated, for maintaining accuracy of the first timestamps; the processing circuit subtracts one from the second data quantity to generate a second difference, and divides a time difference between time points of two polling operations corresponding to the other sensor by the second difference to generate a dividing result as a second time interval between two second samples within the second samples, wherein the second data quantity indicates the number of second samples that are generated in a period between the time points of the two polling operations corresponding to the other sensor; and the processing circuit updates the second time interval to monitor the second time interval, and updates the second polling time latency and the second sensor clock error at least according to the second time interval that is latest updated, for maintaining accuracy of the second timestamps.

14. The apparatus of claim 13, wherein the processing circuit estimates the first polling time latency according to the first time interval that is latest updated, and estimates the first sensor clock error according to the first time interval that is latest updated and according to the first difference; and the processing circuit estimates the second polling time latency according to the second time interval that is latest updated, and estimates the second sensor clock error according to the second time interval that is latest updated and according to the second difference.

15. The apparatus of claim 11, wherein the processing circuit subtracts one from the first data quantity to generate a first difference, and divides a time difference between time points of two polling operations corresponding to the sensor by the first difference to generate a dividing result as a first time interval between two first samples within the first samples, wherein the first data quantity indicates the number of first samples that are generated in a period between the time points of the two polling operations corresponding to the sensor; and the processing circuit updates the first time interval to monitor the first time interval, and updates the first polling time latency and the first sensor clock error at least according to the first time interval that is latest updated, for maintaining accuracy of the first timestamps.

16. The apparatus of claim 15, wherein the processing circuit estimates the first polling time latency according to the first time interval that is latest updated, and estimates the first sensor clock error according to the first time interval that is latest updated and according to the first difference.

17. The apparatus of claim 16, wherein estimation of the first polling time latency is performed according to the first time interval that is latest updated and according to a damping factor of the estimation model, wherein the damping factor emulates damping applied to variation of the polling time latency.

18. The apparatus of claim 11, wherein estimation of the first polling time latency is performed at least according to the first data quantity with aid of an estimation model; and estimation of the first sensor clock error is performed at least according to the first data quantity with aid of another estimation model.

19. The apparatus of claim 11, wherein the processing circuit performs the action according to the sensor data from the sensor and according to the first timestamps, to control the electronic device.

20. The apparatus of claim 11, wherein the sensor comprises a sensor component, an analog-to-digital converter (ADC), and a memory; the ADC performs sampling operations on one or more analogue sensor signals of the sensor component according to a clock signal of the sensor clock of the sensor, to generate sampling results of the sampling operations, wherein the sampling results are stored in the memory as the first samples; and the processing circuit receives the sensor data from the sensor through a digital interface between the processing circuit and the sensor.
